(19) United States
(12) Patent Application Publication
(10) Pub. No.: US 2026/0116491 A1
(43) Pub. Date: Apr. 30, 2026

(54) Machined Bicycle Frame Arrangement

(71) Applicant: Paladin Engineering, LLC, Portland, OR (US)

(72) Inventors: Mitchell Bernards, Portland, OR (US); Stefan Klein, Portland, OR (US); Dylan Thrush, Camano Island, WA (US)

(21) Appl. No.: 19/374,728

(22) Filed: Oct. 30, 2025

Related U.S. Application Data
(60) Provisional application No. 63/713,910, filed on Oct. 30, 2024.

(51) Int. Cl. B62K 19/06; B62K 19/22; B62K 19/24; B62K 19/32; B62K 19/34; B62K 19/36

(52) U.S. Cl. CPC B62K 19/06; B62K 19/22; B62K 19/24; B62K 19/32; B62K 19/34; B62K 19/36

(57) ABSTRACT

The present invention is a novel bicycle frame arrangement that overcomes the limitations of traditional frame construction methods. The invention comprises a single machined frame part that contains at least two complete interfaces configured to accept further bike components, namely a fork assembly, a seatpost assembly, and a crankset assembly, thereby enabling the creation of a frame with improved strength, stiffness, and weight ratios. The remaining frame parts are connected to the first machined component to form one or more substantially hollow portions of the frame, allowing for a robust and efficient structure that can be manufactured from high-strength alloys.

### FIELD OF THE INVENTION

The present invention pertains to bicycle frames. Particularly, the present invention pertains to an arrangement for a bicycle frame comprising a machined frame part.

### BACKGROUND OF THE INVENTION AND PRIOR ART

Traditionally, metal bicycle frames have been constructed from tubes that are cut and welded together. The closed cross-section offers high strength- and stiffness-to-weight ratios, both for bending and torsion loading scenarios, leading to a bike frame that is light, strong, and stiff, all of which are desirable attributes for bike riders.

However, one major drawback to constructing a bike frame from welded tubes is that the specific metal alloy used must be weldable, and may therefore be of reduced strength. This limitation has driven the development of alternative manufacturing methods, including machining.

Machining allows for the use of high-strength metals and alloys that are not suitable for welding. However, when manufacturing parts via machining it is difficult to create the tube-like geometry found on a traditional frame from a single piece of metal, and as a result, these frames suffer from various drawbacks due to the constraints of machining.

To overcome these limitations, some bike frames have been constructed from multiple machined parts that are bonded together at or near the frame's centerline. This creates a stiff tube-like structure, but suffers from drawbacks that hinder the strength of the frame. The assembly of these frames can be complicated, and may even weaken the attachment of certain mating components to the frame.

US Patent Application US20220144373A1 describes one such bicycle frame arrangement comprising two housings joined together along a seam. The connections points to the fork assembly, seat post assembly and crankset assemblies intersect the seam of the two housings. This design suffers drawbacks in that the loads applied to said connection points directly stress the connection between the two housings.

Another approach has been to avoid the use of substantially large, hollow regions in the frame, relying instead on I-beam or H-beam construction, which is machinable from a single part. While this design can provide strength for bending, it suffers from drawbacks that hinder the performance of the frame. I-beam and H-beam cross-sections are substantially more flexible than similar weight hollow cross-sections under torsion loads, requiring the use of thicker walls to increase stiffness, which in turn increases the weight of the frame.

### SUMMARY OF THE INVENTION

The present invention comprises a novel arrangement for a bicycle frame. Said arrangement comprises a first frame part and a second frame part. The first frame part is machined from a single piece of metal and comprises a plurality of connection points configured to receive additional components. The second frame part connects to the first frame part wherein a substantially hollow region is formed by said first frame part and said second frame part. The connection of the first frame part and the second frame part may be achieved via interlocking fastening members, such as screw-like fasteners or rivets, or via adhesives or via welding. The connection points contained in said first frame part may be configured to accept a crankset assembly, a fork assembly and or a seatpost assembly along with any additional components required to facilitate said connections.

### DESCRIPTION OF THE DRAWINGS

Multiple embodiments of the present invention are illustrated as examples and are not limited by the figures of the accompanying drawings, in which like references may indicate similar elements and in which:

FIG. 1 depicts an exploded view of one example of a bike frame arrangement according to the various embodiments of the present invention.

FIG. 2 illustrates a cross section of one example of a bike frame arrangement, showing a substantially hollow region formed within said frame arrangement, according to the various embodiments of the present invention

FIG. 3 depicts an exploded perspective view of one example of a bike frame arrangement according to the various embodiments of the present invention.

FIG. 4 illustrates a cross section of one example of a bike frame arrangement according to the various embodiments of the present invention

FIG. 5 illustrates a cross sectional view of one example of a bike frame arrangement, showing aspects of the substantially hollow region formed within said frame arrangement, according to the various embodiments of the present invention

FIG. 6 illustrates aspects of one example of a bike frame arrangement, showing reference axes about which the stiffness of the frame arrangement can be measured.

FIG. 7 illustrates an exploded side view of one example of a bike frame arrangement according to the various embodiments of the present invention.

FIG. 8 illustrates an exploded side view of one example of a bike frame arrangement according to the various embodiments of the present invention.

FIG. 9 illustrates an exploded side view of one example of a bike frame arrangement according to the various embodiments of the present invention.

FIG. 10 shows a view of an example of a bike frame arrangement assembled into a complete bicycle

### DETAILED DESCRIPTION OF THE INVENTION

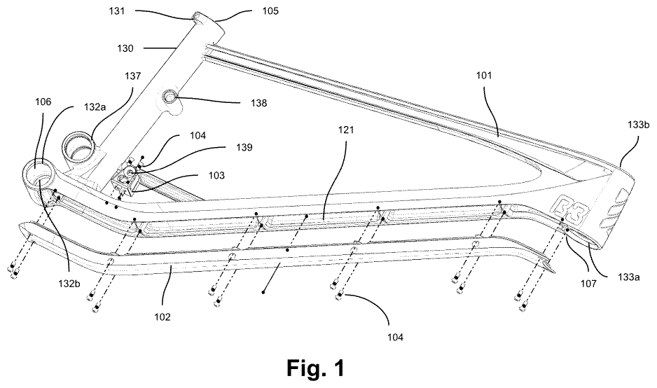

FIG. 1 depicts an exploded view of a drawing of an embodiment of the arrangement in accordance with the present invention.

The embodiment of the arrangement comprises a first frame part (101) which connects to a second frame part (102) and a third frame part (103), said second and third frame parts are interlocked into place via screw-like members (104). Fasteners other than screw-like members can be utilized for this purpose.

At least said first frame part is manufactured using machining. Machining is a manufacturing process wherein a desired shape or part is created using the controlled removal of material, most often metal, from a larger piece of raw material by cutting. Machining is a form of subtractive manufacturing that utilizes machine tools. The machining process for manufacturing metal parts is well known to those of skill in the relevant art. For example, U.S. Pat No. 2,820,187A describes a machining work center that can be utilized to manufacture the machined frame parts described herein. Said US patent is incorporated herein by this reference as though set forth in full.

A substantially enclosed region, such as, e.g., hollow region (121), is formed by the first frame part (101) and the second frame part (102), increasing the stiffness of the frame arrangement. In this embodiment, the hollow region is formed in the bottom of the first frame part.

The primary frame part (101) comprises a first connection point (105) configured to receive a seat post assembly, a second connection point (106) configured to receive a crankset assembly, a third connection point (107) configured to receive a fork assembly and further connection points (137, 138) configured to receive movable rear frame members and suspension elements. Said connection points are contained fully within the first frame part. An intermediate part (103) contains a further connection point (139) configured to receive moveable rear frame members and suspension elements.

Although not explicitly depicted, said fork assembly may comprise a bicycle fork, steer tube, suspension element, headset bearings, bearing cups, bearing supports, brackets, inserts, shims, and sleeves in addition to any other components required to facilitate connection to the frame arrangement.

Although not explicitly depicted, said seatpost assembly may comprise a saddle, a seat post, structural members, adjustable length members, clamps, brackets and shims in addition to any other components required to facilitate connection to the frame arrangement.

Although not explicitly depicted, said crankset assembly may comprise chainrings, cranks, pedals axles, bearings, bearing cups, bearings supports, brackets, inserts, shims, sleeves, motors, gear boxes and shifters in addition to any other components required to facilitate connection to the frame arrangement.

Although not explicitly depicted, said movable rear frame members and suspension elements may comprise structural parts, links, swingarms, chainstays, seatstays, rear triangles, rockers, pivots, bearings, bushings, inserts, brackets, bearing supports, shock absorbers, springs, dampers, derailleurs and brakes in addition to any other components required to facilitate connection to the frame arrangement.

In this embodiment the first connection point (105), configured to receive a seatpost assembly, comprises a first interface, such as, e.g., a tube like section (130), into which the seatpost assembly is inserted into and a collar clamp (131) formed into the first frame part, configured to clamp the seatpost assembly, securing it to the primary frame part. In other embodiments said connection point may take on different forms and feature wedges, separate clamps, press fits and threaded interfaces.

In some embodiments, the first connection point 105, configured to receive the seatpost assembly, may facilitate motion of the seatpost assembly in and out of the first frame part via the use of mechanical elements, such as hydraulics, pneumatics, cables, or electric motors. In said embodiment the connection point may comprise contact to fluids, seals, threads, lead screws, bushings and various seatpost assembly components, some of which may move with the seatpost assembly and some of which may remain stationary relative to the first frame part.

In this embodiment the second connection point (106), configured to receive the crankset assembly, comprises a second interface, such as, e.g., a pair of threads (132a, 132b), configured to receive the crankset assembly. In other embodiments said connection point may take on different forms and comprise press fits, thread patterns, clamps, alignment features and faying surfaces intended to align and secure the crankset assembly to the frame arrangement.

In this embodiment the third connection point (107), configured to receive a fork assembly, comprises a third interface, such as, e.g., a pair of conical faces (133a, 133b), configured to receive and align the fork assembly to the frame arrangement. In other embodiments said connection point may take on different forms including but not limited to oblong interfaces that may rotationally align parts of the fork assembly, threads into which parts of the fork assembly may be threaded into, thread patterns into which adapters on the fork assembly may be fastened to and clamps which may facilitate retention of the fork assembly to the frame arrangement.

In this embodiment the further connection points (137,138,139), configured to receive movable rear frame members and suspension elements, comprises a set of further interfaces, such as, e.g., a set of threaded holes (138,139), configured to receive movable rear frame members and suspension element assembly to the frame arrangement. In other embodiments said connection point may take on different forms including but not limited to bores to receive bearings, bushings, bearing cups or sleeves, threaded holes to receive screws, bearing supports, in the first, second or third frame parts.

In some embodiments one of the connection points (105, 106, 107), configured to receive either the seat post assembly, crankset assembly, or fork assembly may be either fully or partially contained in the second, third, fourth, etc. frame parts, with the remaining two connection points being fully contained within the first frame part.

In this embodiment, the first, second and third frame parts (101, 102, 103) are machined from solid aluminum billets. Said parts may be machined from multiple oblique planes to form the target part shapes within the constraints of machining.

The first, second and third frame parts (101, 102,103) may be machined from metals other than aluminum to gain the benefits of different material properties e.g. magnesium, titanium or steel alloys. Further, frame parts not containing a plurality of connection points, (102, 103) may be produced from non metallic materials e.g. composites, plastics, or natural fibers.

Additional frame parts may be added to the arrangement to enable working around various constraints and challenges. To provide a few examples, the addition of said frame parts may reduce material costs, increase machining throughput, improve aesthetics, and enable easier sourcing of raw materials.

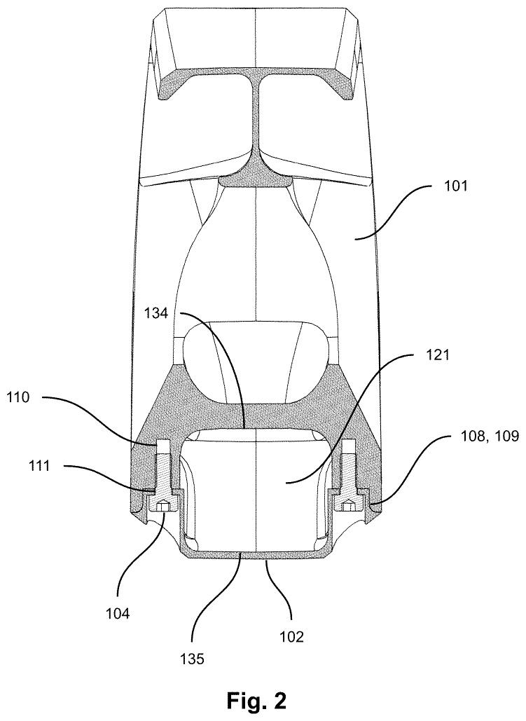

FIG. 2. depicts a cross sectional view of an embodiment of the arrangement (100) in accordance with the present invention.

As depicted in this embodiment the second frame part (102) may be removably connected to the first frame part (101). This connection may be facilitated by screw-like members (104) as depicted. The removable connection and screw-like fastening therefore enables fast assembly of the frame arrangement (100) and replacement of the second frame part, which is beneficial e.g. to replace damaged frame parts or to access items that may be stored in the hollow region formed within the frame arrangement.

The first frame part (101) and second frame part (102) may be connected via similar screw-like fastening means e.g. nuts and or threaded studs. Further, the first frame part (101) and the second frame part (102) may be connected via deformable fasteners e.g. rivets. In other embodiments adhesives and or welded connections may be used in conjunction with, or in place of, the interlocking fasteners

In this embodiment a rabbet type joint is formed between the faying surfaces of the first frame part (108) and the faying surfaces of the second frame part (109). Additionally, a set of threads (110) are formed into the first frame part (101) and a corresponding set of clearance holes (111) are formed into the second frame part. The screw-like members (104) interlock the second frame part (102) to the first frame part (101) via the threads and the clearance holes. The tightening of the screw-like members maintains contact between the first frame part and the second frame part during loading scenarios, contributing to the stiffness of the frame arrangement.

The threaded holes and the clearance holes may be swapped between the first frame part and the second frame part. Certain embodiments may use both clearance holes and threads on any given frame part.

In this embodiment a substantially hollow region (121) is formed within the frame arrangement between the first frame part (101) and the second frame part (102). Specifically, said substantially hollow region is formed by a first inner surface (134) of the first frame part, and a second inner surface (135) of the second frame part. In this embodiment, the contours of the first and second inner surfaces each resemble a trench, thereby forming a concave cavity (or substantially hollow region) between the first and second frame parts respectively.

In this exemplary embodiment, the trench-like first inner surface and the trench-like second inner surface vary in width between approximately 30 millimeters to 60 millimeters, narrowing in width near the threads and the clearance holes. The depression of said trench-like first inner surface is approximately 20 millimeters deep into said first frame part and the depression of said trench-like second inner surface is approximately 15 millimeters deep into said second frame part. Said first and second inner surfaces are located between the connection point configured to receive a fork assembly and the connection point configured to receive a crankset assembly and are each approximately 750 millimeters long.

In other embodiments the first inner surface and the second inner surface may be concave, flat and or convex in form and may range from 5 millimeters up to 150 millimeters in width, from 5 millimeters up to 900 millimeters in length and from 0 millimeters up to 150 millimeters in depth.

In other embodiments the substantially hollow portion of the frame may be formed between first and second inner surfaces of varying geometry. In some embodiments a substantially hollow region may be formed between a trench-like first inner surface formed into one of the frame parts and a substantially flat, or even convex, second inner surface formed into the second frame part.

Other embodiments may include third, fourth, fifth, etc. frame parts, said frame parts being connected to each other, the first frame part and or the second frame part. In said embodiments the substantially hollow region of the frame arrangement may be formed between some or all of the second, third, fourth, etc. inner surfaces formed into the second, third, fourth, etc. frame parts.

In other embodiments more than one substantially hollow region may be formed within the frame arrangement. Multiple regions may either be adjacent to each other, separated by reinforcement ribs, or they may be located in different regions of the frame arrangement to increase the stiffness of different regions.

Additional faying surfaces may be formed into the first frame part and the second frame parts to align any threaded features and or fastener holes during assembly to ensure alignment of the fasteners. Furthermore, these faying surfaces may be arranged in a manner to transmit loads between the first and second frame parts about axes orthogonal to the screw-like members.

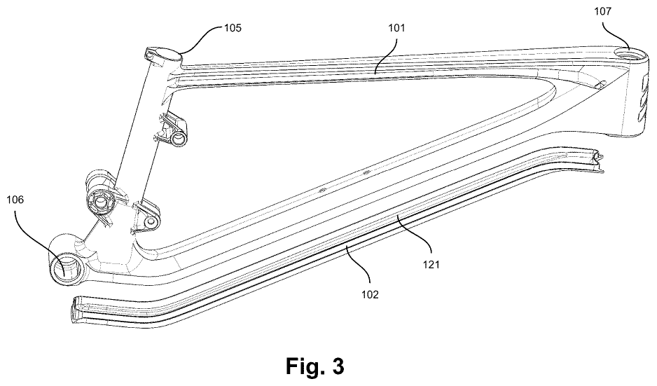

FIG. 3 depicts an exploded view of a drawing of an embodiment of the arrangement (100) in accordance with the present invention.

The embodiment of the arrangement comprises a first frame part (101) which connects to a second frame part (102) via a bonded interface. The first frame part (101) comprises a first connection point (105) configured to receive a seat post assembly, a second connection point (106) configured to receive a crankset assembly and a third connection point (107) configured to receive a fork assembly. Said connection points (105, 106, 107) are contained fully within the first frame part.

A substantially hollow region (121) is formed within the frame arrangement which is bounded by the first frame part and the second frame part.

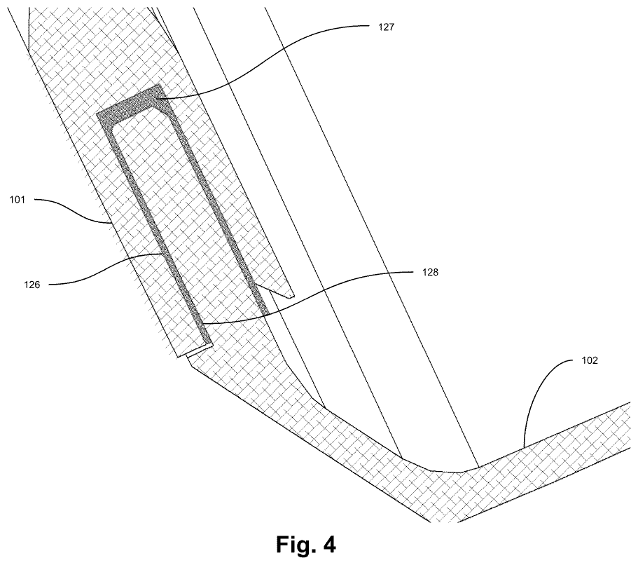

FIG. 4 depicts a cross sectional view of an embodiment of the arrangement (100) in accordance with the present invention.

The connection of the first frame part (101) to the second frame part (102) via an adhesive (127) is shown in detail. Faying surfaces (126) on the first frame part may be formed in the shape of a slot, into which the adhesive (127) may be dispensed. Faying surfaces (128) on the second frame part may be formed such that when connected to the first frame part (101) a glue gap is formed, into which the dispensed glue flows into. The glue gap may resemble “U”, “L”, or “I” shapes depending on the structural needs of the connection. Optionally, the cross section of the glue gap may change along the length of the connection.

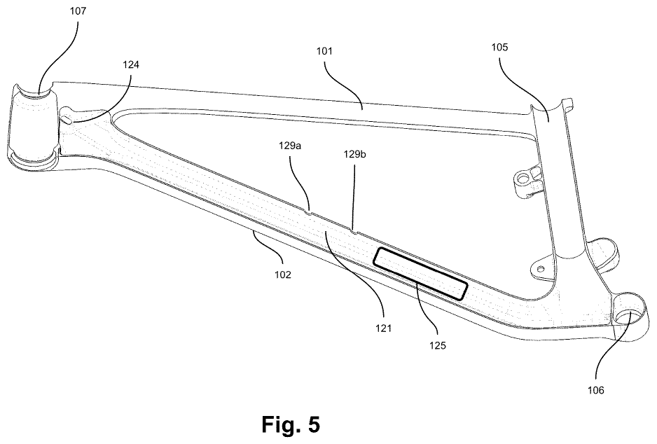

FIG. 5 depicts a cross sectional view of an embodiment of the arrangement (100) in accordance with the present invention.

In some embodiments the substantially hollow region formed within the frame arrangement (121) may have one or more openings through the first frame part (101) and or the second frame part (102) to provide utility to the frame arrangement. Cable openings (124) may allow for cables to enter and or exit the substantially hollow region formed within the frame arrangement, which is beneficial e.g. to protect cables from damage that may occur, or to route them across the frame arrangement.

Additionally, the substantially hollow region formed within frame arrangement (121) may have one or more openings through the first frame part (101) and or the second frame part (102) to provide connection points to which further accessories can be mounted and or accessed. As depicted, a pair of openings (129a, 129b) are present in the frame arrangement that are configured to accept fasteners and or threaded inserts which may be used to mount a water bottle to the frame arrangement.

Although not explicitly depicted, larger openings may allow for snacks, tools, clothing and other items to be stored inside of the substantially hollow region formed within the frame arrangement. These openings may be fully or partially sealed by additional frame parts. In some embodiments openings may permit the installation and service of battery or motor components.

In some embodiments the substantially hollow region formed within the frame arrangement may be characterized by the ability for a cylinder (125) of a specific size, to remain trapped inside of the substantially hollow region formed within the frame arrangement if inserted during assembly.

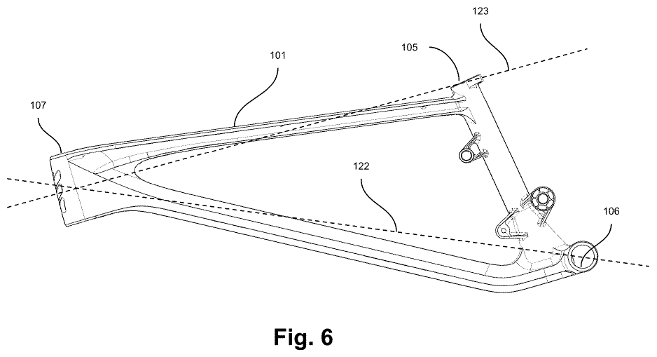

FIG. 6 depicts an annotated view of an embodiment of the arrangement (100) in accordance with the present invention.

In some embodiments the torsional stiffness of the frame arrangement can be characterized about a down tube axis (122) that intersects a first connection point (107) configured to receive a fork assembly and a second connection point (106) configured to receive a crankset assembly. The frame arrangement may be at least 10% stiffer about said down tube axis than the first frame part (101) is, when measured on its own.

For example, stiffness about the the down tube axis (122) may be measured at 1000 Nm/radian when the second frame part (102) is not attached to the first frame part (101). It may then be measured at 1100 Nm/radian, or more, when the second frame part (102) is attached to the first frame part (101) forming the substantially enclosed region, e.g. hollow region (121).

In some embodiments the torsional stiffness of the frame arrangement can be characterized about a top tube axis (123) that intersects a first connection point (107) configured to receive a fork assembly and a third connection point (105) configured to receive a seat post assembly. The frame arrangement may be at least 10% stiffer about said top tube axis than the primary frame part (101) is, when measured on its own.

For example, stiffness about the the top tube axis (123) may be measured at 1000 Nm/radian when the second frame part (102) is not attached to the first frame part (101). It may then be measured at 1100 Nm/radian, or more, when the second frame part (102) is attached to the first frame part (101) forming the substantially enclosed region, e.g. hollow region (121).

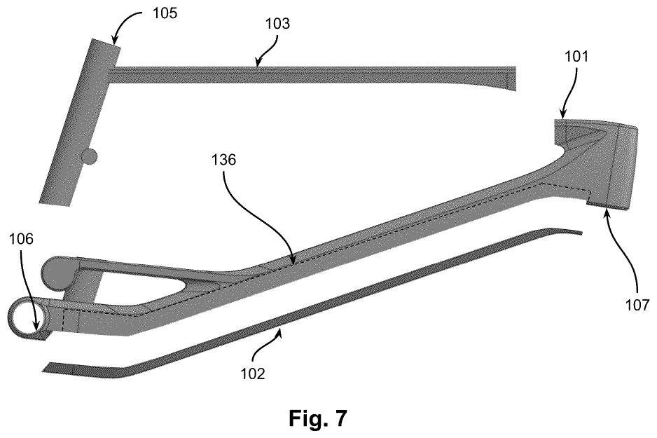

FIG. 7 depicts an exploded side view of an embodiment of the arrangement (100) in accordance with the present invention.

The embodiment of the arrangement comprises a first frame part (101) which is machined from a solid piece of metal and connects to a second frame part (102) and a third frame part (103). The first frame part comprises a complete first connection point (106) configured to receive a crankset assembly and a complete second connection point (107) configured to receive a fork assembly. Although not explicitly depicted, the second frame part (102) may be interlocked with the primary frame part (101) via the use of one or more fastening members. Said fastening members may be screw-like fasteners such as screws, nuts or studs and or deformable fasteners such as rivets, roller pins or snap fasteners.

A dashed line (136) indicates the position of a substantially hollow region formed within the frame arrangement. Said substantially hollow region is bounded by the first frame part (101) and the second frame part (102). Optionally, further frame parts may bound the substantially hollow region formed within the frame arrangement.

Optionally, the second frame part (102) may be metallic and bonded to the first frame part via a glued interface in replacement of the fastening members.

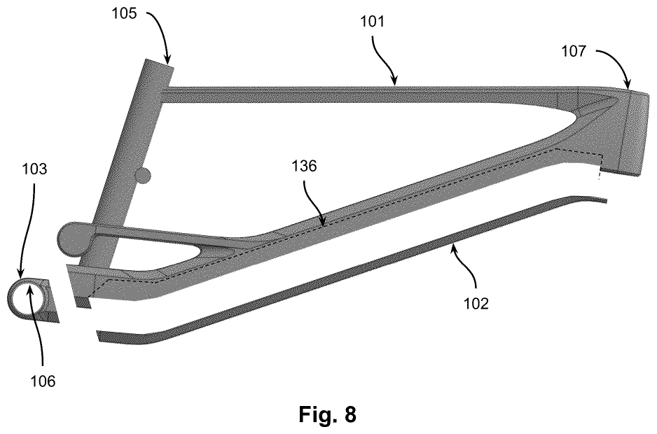

FIG. 8 depicts an exploded side view of an embodiment of the arrangement (100) in accordance with the present invention.

The embodiment of the arrangement comprises a first frame part (101) which is machined from a solid piece of metal and connects to a second frame part (102) and a third frame part (103). The first frame part comprises a complete first connection point (105) configured to receive a seatpost assembly and a complete second connection point (107) configured to receive a fork assembly. Although not explicitly depicted, the second frame part (102) may be interlocked with the primary frame part (101) via the use of at least one fastening member. Although not explicitly depicted, the third frame part (103) may comprise motors, electronics, gears, springs, pulleys, derailleurs, shifters, shift cables, belts, chainrings, mechanical transmission elements and connection points to movable rear frame members and suspension elements.

A dashed line (136) indicates the position of a substantially hollow region formed within the frame arrangement. Said substantially hollow region is bounded by the first frame part (101) and the second frame part (102). Optionally, additional frame parts may bound the substantially hollow region formed within the frame arrangement.

Optionally, the second frame part (102) may be metallic and bonded to the first frame part via a glued interface in replacement of the fastening members.

Optionally, the third frame part (103) may comprise a gearbox assembly or a motor assembly.

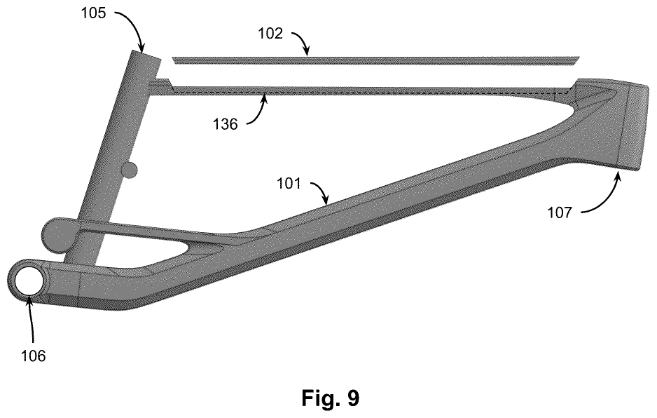

FIG. 9 depicts an exploded side view of an embodiment of the arrangement (100) in accordance with the present invention.

The embodiment of the arrangement comprises a first frame part (101) which is machined from a solid piece of metal and connects to a second frame part (102). The first frame part comprises a complete first connection point (106) configured to receive a crankset assembly, a complete second connection point (107) configured to receive a fork assembly and a complete third connection point (105) configured to receive a seatpost assembly. Although not explicitly depicted, the second frame part (102) may be interlocked with the first frame part (101) via the use of at least one fastening member.

A dashed line (136) indicates the position of a substantially hollow region formed within the frame arrangement. Said substantially hollow region is bounded by the first frame part (101) and the second frame part (102). Additional parts may bound the substantially hollow region formed within the frame arrangement.

Optionally, the second frame part (102) may be metallic and bonded to the first frame part via a glued interface in replacement of the fastening members. This provides benefits in that less material needs to be left on either the primary frame part or the secondary frame part, and provides similar materials on each side of the bonded joint, allowing for the use of specialized adhesives.

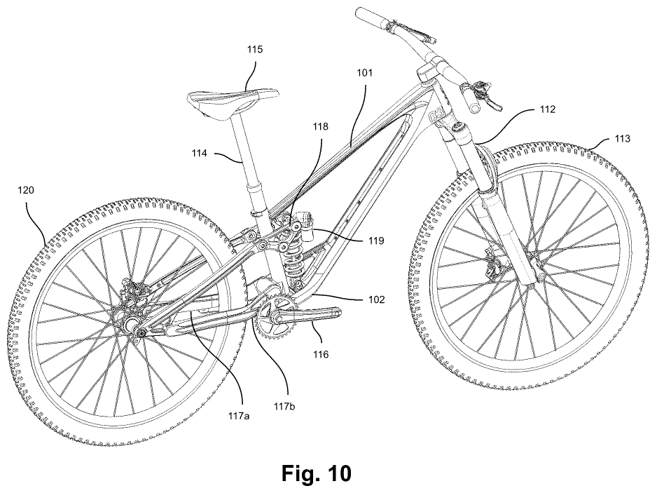

FIG. 10 depicts a general view of the use of an embodiment of the arrangement (100) in accordance with the present invention in a bicycle frame arrangement.

The present embodiment of the arrangement connects to a fork assembly (112) which comprises a front wheel (113), a seatpost assembly (114) which comprises a seat (115), a crankset assembly (116) which comprises a pair of cranks, a plurality of movable rear frame members (117a, 117b, 118) and a suspension element (119). The movable rear frame members further connect to a rear wheel (120).

In other embodiments the frame arrangement may connect directly to the rear wheel via connection points for an axle which may be formed into either the primary frame part, a secondary frame part, or a plurality of frame parts.

What is claimed:

1. An apparatus, comprising
a first frame part;
a second frame part;
wherein the first frame part is machined from a single billet of metal,
wherein a substantially hollow region is formed at least partially from a coupling of the second frame part to the first frame part,
wherein the first frame part fully contains a connection point for receiving a fork assembly, and
wherein the first frame part fully contains another connection point for receiving a crankset assembly.

2. The apparatus of claim 1,
wherein the stiffness of the assembly of the first and second frame parts is at least 10% torsionally stiffer than the first frame part on its own about the down tube axis.

3. The apparatus of claim 1,
wherein the stiffness of the assembly of the first and second frame parts is at least 30% torsionally stiffer than the first frame part on its own about the down tube axis.

4. The apparatus of claim 1,
wherein the second frame part comprises a metallic material.

5. The apparatus of claim 1,
wherein the first frame part fully contains a connection point for receiving a seat post assembly.

6. The apparatus of claim 5,
wherein the stiffness of the assembly of the first and second frame parts is at least 10% torsionally stiffer than the first frame part on its own about the down tube axis.

7. The apparatus of claim 5,
wherein the stiffness of the assembly of the first and second frame parts is at least 30% torsionally stiffer than the first frame part on its own about the down tube axis.

8. The apparatus of claim 5,
wherein the second frame part comprises a metallic material.

9. The apparatus of claim 5,
wherein the first frame part fully contains one or more connection points for receiving additional movable rear frame members and suspension elements.

10. The apparatus of claim 9,
wherein the stiffness of the assembly of the first and second frame parts is at least 10% torsionally stiffer than the first frame part on its own about the down tube axis.

11. The apparatus of claim 9,
wherein the stiffness of the assembly of the first and second frame parts is at least 30% torsionally stiffer than the first frame part on its own about the down tube axis.

12. The apparatus of claim 9,
wherein the second frame part comprises a metallic material.

13. An apparatus, comprising
a first frame part;
a second frame part;
wherein the first frame part is machined from a single billet of metal,
wherein a substantially hollow region is formed at least partially from a coupling of the second frame part to the first frame part,
wherein the first frame part fully contains a connection point for receiving a fork assembly, and
wherein the first frame part fully contains another connection point for receiving a seat post assembly.

14. The apparatus of claim 13,
wherein the stiffness of the assembly of the first and second frame parts is at least 10% torsionally stiffer than the first frame part on its own about the top tube axis.

15. The apparatus of claim 13,
wherein the stiffness of the assembly of the first and second frame parts is at least 30% torsionally stiffer than the first frame part on its own about the top tube axis.

16. The apparatus of claim 13,
wherein the second frame part comprises a metallic material.

17. The apparatus of claim 13,
wherein the first frame part fully contains one or more connection points for receiving additional movable rear frame members and suspension elements.

18. The apparatus of claim 17,
wherein the stiffness of the assembly of the first and second frame parts is at least 10% torsionally stiffer than the first frame part on its own about the top tube axis.

19. The apparatus of claim 17,
wherein the stiffness of the assembly of the first and second frame parts is at least 30% torsionally stiffer than the first frame part on its own about the top tube axis.

20. The apparatus of claim 17,
wherein the second frame part comprises a metallic material.
